(19) United States
(12) Patent Application Publication
(10) Pub. No.: US 2011/0259907 A1
(43) Pub. Date: Oct. 27, 2011

(54) MULTIFUNCTION SYSTEM

(76) Inventor: Gerard Kuma, Nice (FR)

(21) Appl. No.: 12/875,617

(22) Filed: Sep. 3, 2010

(30) Foreign Application Priority Data
Apr. 22, 2010 (FR) 10/01725
Apr. 22, 2010 (FR) 10/01726

(51) Int. Cl. B65D 83/00; A63B 43/00; B02C 19/00

(52) U.S. Cl. 221/1; 241/101.2; 473/569; 221/97

(57) ABSTRACT

The invention relates to a multifunction system comprising a first module (1) for the automatic distribution of articles and a second module (21) for recovery of used or unusable tennis balls and/or empty tubes of tennis balls.

This invention relates to the field of the automatic distribution of articles, in particular of balls for sports, and more particularly the field of the preservation, storage and recycling of balls for sports, in particular tubes of tennis balls.

Tennis balls are comprised of 53 grams of rubber and light felt that wither rather quickly. It is also the most renewed consumable items due to its rather brief lifespan. In France, about fifteen million balls are sold each year, which makes tennis the 5th most polluting sport (Sport et Vie Magazine—January 2007).

The game of the player is affected by a ball which is losing its elasticity and which has an erratic behavior. As such, the club competitor exhausts the qualities of a tennis ball in two to four hours of play, while in international tournaments; each ball can be used only for nine games in accordance with the current legislation (seven to nine games on an ATP tour in forty-five minutes of play).

It results from the preceding that the type of balls sought by the player will depend on his level of play. It is therefore obvious that is the major competitors and professionals are indifferent to the parameters of longevity and cost price benefiting an exceptional quality; this is not the same for the regular player who requires from the ball a good level of performance along with a satisfactory longevity.

The occasional or debutante player is content rather with a low-end ball of which the drop in quality is necessarily compensated by a significant decrease in the sales price. Note that the balls in the tennis clubs are by far above all quality balls.

To date, tubes of tennis balls are substantially distributed via the mass distribution sports stores, stores specializing in sports equipment. Mail order and internet media internet remain alternatives that are still secondary as they are emerging. Within the tennis clubs, a more or less organized making available of tubes of balls sometimes allows the player to purchase new balls on site.

Tennis clubs substantially purchase their stock of pressurized balls in the mass distribution stores in the form of cartons of 18, 24 or 36 tubes or in the form of barrels of balls. The tubes are intended for the most part to meet the own needs of these clubs within the framework of tournaments and competitions that they organize all throughout the year, then for selling to their members.

The observation of the uses within clubs shows that none of the distribution networks is fully satisfactory, in particular for reasons of geographical proximity and management. Indeed, a service that is not guaranteed during the entire range of opening time of the courts, the availability of the personnel or benevolent persons according to the organizational diagram of clubs, the cash register problems or making change, combined with the difficulties inherent to the management of stocks makes making new tennis balls available to the players difficult.

Furthermore, another major problem which occurs in tennis clubs in particular, relates to the storage and recycling conditions of balls. It seems indeed that the storage of balls in inappropriate premises, i.e. which can be subjected to substantial temperature differences can alter the properties of tennis balls. So, it is therefore essential to ensure that the properties of the tennis balls remain constant and unchanged before they are used.

It does effectively happen that tennis balls are, even before they are used, unusable in a game situation. The modifications of the properties of the balls can be due to environmental factors such as in particular substantial differences in temperature, humidity and/or pressure.

Likewise, the tubes of tennis balls, according to the materials that they are comprised of, can also be subjected to changes in form under certain conditions of pressure and/or temperature, making the product improper for sale.

The collection or recovery of tennis balls and of tubes of tennis balls with a view to recycling them is also a problem in tennis clubs. To date, there are no solutions that have a low greenhouse gas impact.

It is known from document FR 2 620 548, the use in a tennis club, of an automatic distributor in monitored premises to deliver balls contained in their original tube by the intermediary of a change machine.

Automatic tennis ball tube distributors with high robustness are also known in document FR 2 604 277. These automatic distributors are, according to this document, well adapted to be arranged outdoors, as well as in an enclosed environment or on the tennis courts.

Finally, document FR 2 616 566 further discloses a device intended for the distribution of tubes containing tennis balls.

However, none of the distributors according to the documents hereinabove incorporate the possibility of recovering the tubes of tennis balls or the used or unusable tennis balls.

Also, an objective of this invention is to provide a system making it possible to deliver articles and in particular tennis balls and/or tubes of tennis balls, as well as providing the possibility of recovering within said system tubes of tennis balls or used or unusable tennis balls, this with an aim to their future recycling.

The invention therefore has for first objet a multifunction system comprising:
a first module for the automatic distribution of articles, preferably tennis balls; and
a second module for recovering used or unusable tennis balls or empty tennis ball tubes.

Indeed, the Applicant has been able to demonstrate that by associating within the same system, a function for the automatic distribution of articles, in particular of tennis articles such as tennis balls and/or tubes of tennis balls, and a function for recovering empty tubes of tennis balls and used or unusable balls, it becomes possible to respond to an expectation of the tennis clubs in terms of local services. Likewise, the function of recovering empty tubes of tennis balls and used or unusable balls allows clubs to take part in a sustainable development approach making it possible to reduce the costs of waste management as well as their greenhouse gas inventory. Indeed, once the waste has been collected in a single point, the taking up of said waste and the collection of the balls can be accomplished synchronously in a single operation. More preferably, the first module for distribution and the second module for recovery are maintained integral.

Advantageously, the collection or recovery of empty tubes of tennis balls and of used or unusable balls can be combined with the supplying of the distribution portion of the system, the two steps being carried out in a single operation by the service provider.

None of the documents from prior art suggest to combine, within the same system, a distribution module and a recovery module.

The invention also has as a second object a method for distributing and recovering balls for sports, preferably tennis balls, comprising the steps of filling a first module for the automatic distribution of articles; distributing said articles for payment of a corresponding sum; and collecting of used or unusable tennis balls, of empty tubes of tennis balls and/or of other organic or inorganic waste.

The invention has for third object the use of an automatic multifunction system allowing for the distribution of tubes of balls and of tennis balls, the recovery and/or the reduction of said tubes and tennis balls, before their recycling.

Finally, the invention has for fourth object a tube of tennis balls stored in a system according to the invention.

Other purposes, advantages and characteristics of the invention shall be better understood when reading the following description and preferred embodiments, which are not restrictive, of the objet and of the scope of this patent application and which are drafted with regards to the annexed drawings, wherein:

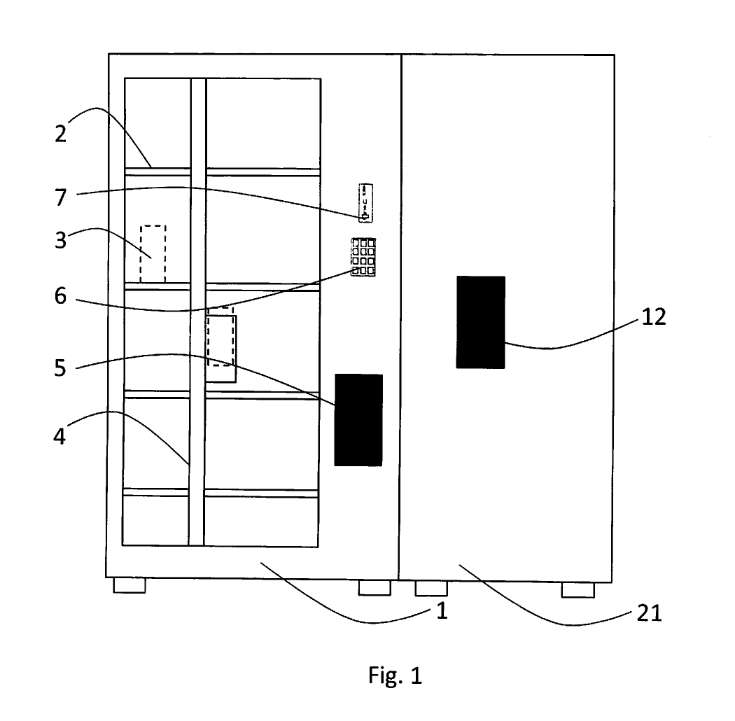

FIG. 1 diagrammatically shows a front view of an embodiment of the multifunction system according to the invention;

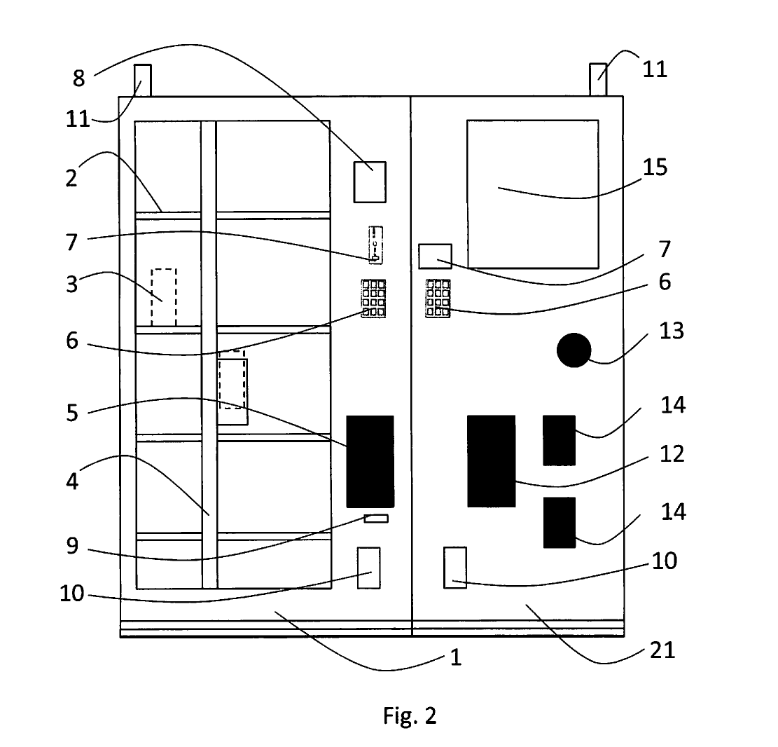

FIG. 2 diagrammatically shows a front view of a second embodiment of the multifunction system according to the invention;

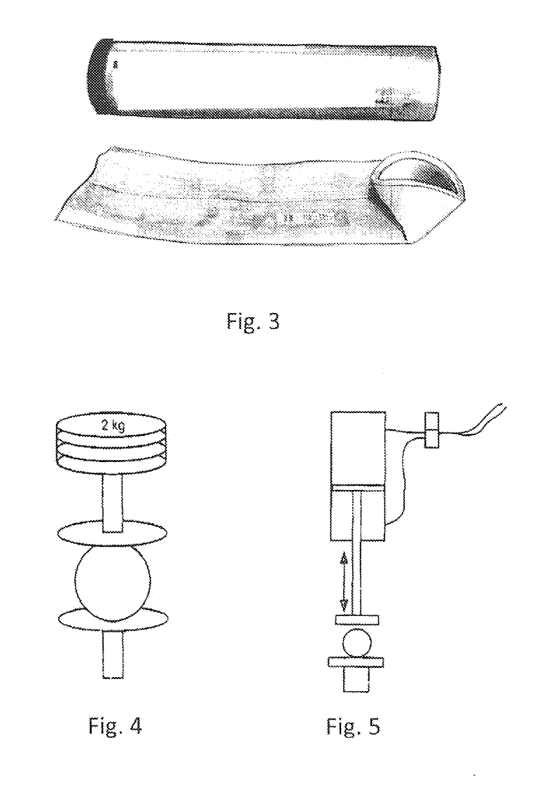

FIG. 3 shows a front photograph of tubes of tennis balls before and after the reduction of their size by crushing;

FIGS. 4 to 9 show front views of different possible alternatives of tools for measuring the performance of balls that can be used;

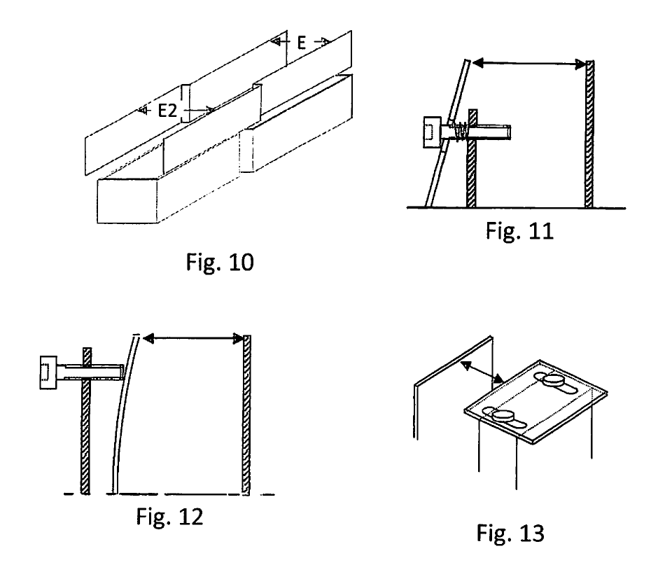

FIG. 10 shows a sagittal view of a system for filtering tennis balls according to the invention;

FIGS. 11 and 12 show different tightening systems making it possible to maintain a constant separation between the rails of the system for filtering tennis balls; and

FIG. 13 shows a sagittal view of a tightening system making it possible to maintain a constant separation between the rails of the system for filtering tennis balls.

FIGS. 1 and 2 show different possible alternatives of embodiments of automatic multifunction systems according to the invention. As such, according to FIGS. 1 and 2, the systems include a first module for distributing articles 1, allowing for the distribution of articles such as in particular the balls for sports or the tubes comprising the balls for sports 3. Said articles 3 are arranged on stages 2 and can be delivered at a bin for recovering the product and/or change 5 by a motorized elevator 4 in a plane in X and Y. More preferably, the elevator is activated after insertion of the corresponding sum in a means of payment 7 and after composition of the code making it possible to deliver the chosen product on a selection keyboard 6. The systems shown in FIGS. 1 and 2 further contain a second module for recovering used or unusable tennis balls and/or empty tubes of tennis balls 21. The recovery of the tennis balls and of the tubes can be carried out by the same entry 12 such as shown in FIG. 1, or by two different entries 12, 13 such as shown in FIG. 2.

Among the articles likely to be delivered by the first module 1 according to the invention, products that can be refrigerated chosen from among tennis accessories, beverages and/or food can also be mentioned. By way of non-restricted examples of tennis accessories, racket overgrips, anti-vibration systems or tennis wristbands can be mentioned. By way of non-restricted examples of beverages, mineral waters, fruit juices or sodas can be mentioned, in conventional formats of 25 cl, 33 cl, 50 cl or 125 cl.

By way of non-restricted examples of food, products enriched with carbohydrates can be mentioned, in particular products adapted for athletes such as energy-providing mineral waters.

More preferably, the balls for sports delivered by the first module 1 are tennis balls. More preferably still, said tennis balls are contained in tubes, also called tennis ball cans.

Among the other distribution mechanisms that can be used for the first module 1 according to the invention, spirals, conveyor belts or revolving doors can be mentioned by way of non-restricted example. As shown in FIGS. 1 and 2, in a preferred manner, the distribution mechanism of the first module 1 according to the invention is a motorized elevator in a plane in X and Y, more preferably encore, the elevator consists in a robotized arm system in a plane in X and Y. This distribution mechanism has the advantage of gently delivering the products thanks to its robotized arm system.

More preferably, the first module 1 according to the invention further comprises a means of payment. By way of non-restricted examples of means of payment, change machines, card readers, bank note acceptors or contactless payments can be mentioned in particular. Advantageously, the means of payment is a change machine 7 such as shown in FIGS. 1 and 2.

By way of non-restricted example of a card reader, bank card readers and the electronic wallet can be mentioned such as in particular the Moneo® electronic wallet available in France.

The distribution module 1 according to the invention can contain more preferably between 10 and 100 rows of balls or tubes of balls, each row comprising between 4 and 30 balls or tubes of balls. More preferably still, the module 1 comprises between 20 and 64 rows of balls or tubes of balls, each row comprising between 6 and 10 balls or tubes of balls.

Advantageously, the height of the first module 1 according to the invention is between 1200 and 2400 mm, more preferably between 1400 and 2000 mm, more preferably still, the height is 1830 mm.

The width of the first module 1 according to the invention is preferentially between 400 and 1600 mm, more preferably still between 750 and 990 mm.

The depth of the first module 1 according to the invention is preferentially between 400 and 1500 mm, more preferably still, the depth is approximately 870 to 880 mm.

The weight of the first module 1 according to the invention is preferentially between 200 and 1000 kg, more preferably still, the weight is approximately 400 kg.

According to the invention, the system further includes a waste recovery module 21. In order to be in line with an ecological approach, the system according to the invention is also capable of recovering not only the used or unusable tennis balls, but also the empty tubes of tennis balls, as well as the miscellaneous waste, i.e. organic or inorganic, left by the players on the courts such as beverage cans or bottles. Advantageously, the second module 21 according to the invention recovers the other organic or inorganic waste, via the same entries 12 and/or 13, or via one or several additional entries 14 as shown in FIG. 2.

Organic waste here means fermentable waste. This is residue of plant or animal origin which can be broken down by micro-organisms for which they represent a source of food. They include in particular plants, putrescible waste, dirty papers and cartons.

Inorganic waste here means solid waste with a glass, paper, metal base and plastic materials. By way of non-restricted examples of inorganic waste, products that can be recycled can be mentioned such as beverage cans, plastic or glass bottles or carton bricks.

Preferably, the waste recovery module 21 must be able to recover all of the components of tennis balls and of tubes of tennis balls. As such, said recovery module is in particular able to recover materials made of tin, aluminum, polyethylene terephtalate (PET), low-density polyethylene (PEBD) and polypropylene (PP).

Advantageously, the height of the second module 21 according to the invention is between 1200 and 2400 mm, more preferably between 1400 and 2000 mm, more preferably still, the height is 1830 mm.

The width of the second module 21 according to the invention is preferentially between 150 and 1200 mm, more preferably still between 200 and 400 mm.

The depth of the second module 21 according to the invention is preferentially between 400 and 1500 mm, more preferably still, the depth is approximately 870 to 880 mm.

The weight of the second module 21 according to the invention is preferentially between 20 and 1000 kg, more preferably still, the weight is approximately 70 kg.

Advantageously, said second module has a capacity making it possible to contain the equivalent in volume of the content in tennis balls of the first module according to the invention.

According to a first alternative as shown in FIG. 1, the waste recovery module 21 comprises a single entry 12. This single entry has for advantage to reduce the encumbrance, the costs of manufacture, maintenance and energy consumption.

According to a second alternative, as shown in FIG. 2, the waste recovery module 21 comprises several entries 12, 13 and/or 14. This plurality of entries allows for the realization of a selective sorting of balls, tubes and/or waste and this, before the step of collection with a view to recycling.

Advantageously, the waste recovery module 21 further incorporates a reducer of balls, tubes and/or waste.

The reduction can be realized advantageously by crushing or by shredding. Crushing procures the advantage of reducing the volume of waste, up to a 75% reduction for metal tubes of balls, as is shown in FIG. 3. The shredding has for advantage to reduce the volume of the waste of the ball, plastic tube of balls type, and this, with high efficiency.

According to a particular embodiment of the invention, the system according to the invention further includes, in place of, or as a supplement, or incorporated into the waste recovery module 21, a module for measuring the performance of tennis balls. Indeed, the quality of the balls is an important element for the level of play but also for the comfort of the user.

According to a first alternative, among the tools for measuring the performance of the tennis balls that can be used according to the invention, the use of a weight system can be mentioned such as shown in FIG. 4. According to this system, the effort is provided by the use of weights dimensioned according to the value of the effort desired, and by gravity. This system makes it possible to apply an effort that is perfectly constant on the ball, while remaining reliable and simple to use.

According to a second alternative, among the tools for measuring the performance of the tennis balls that can be used according to the invention, the use of a pneumatic or hydraulic cylinder can be mentioned such as shown in FIG. 5. According to this system, the effort is provided by the use of a double-acting pneumatic or hydraulic cylinder. This system makes it possible to apply a constant effort on the ball during the entire duration of the test and offers a possibility of adjusting the level of effort by simply adjusting the pressure in the cylinder.

According to a third alternative, among the tools for measuring the performance of the tennis balls that can be used according to the invention, the use of an electric cylinder can be mentioned such as shown in FIG. 6. This system allows for a fine adjustment of the parameters such as the speed or the effort and makes it possible to substantially decrease the number of parts that comprise the cylinder.

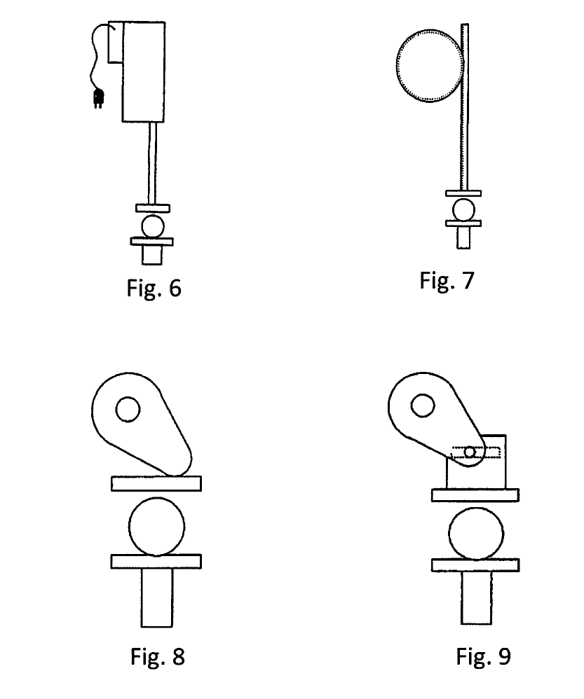

According to a fourth alternative, among the tools for measuring the performance of the tennis balls that can be used according to the invention, the use of an electric motor can be mentioned such as shown in FIGS. 7, 8 and 9. According to this system, the effort is provided by the use of an electric motor of which the torque is maintained constant. The rotating movement is transformed into linear movement by the intermediary of a mechanical system. The possible alternatives can be for example of the rack or pinion type such as shown in FIG. 7, of the cam system type such as shown in FIG. 8 or other alternatives such as shown in FIG. 9. This system allows for a fine adjustment of the level of effort and offers the possibility of having several solutions possible for transforming the motor torque into linear effort.

More preferably, in order to protect the system from abuse, it is preferable to filter the objects at the entry of the module for measuring the performance of tennis balls, so that only tennis balls are tested and that the other objects are redirected towards the exit without passing through this test phase. This filtering can be carried out either by a diameter inspection of the tennis ball, or via a weight inspection of the tennis ball, or via a visual inspection, i.e. of the shape or of the color of the ball. More preferably encore, the filtering is carried out by a simple inspection of the diameter of the ball. According to this device, it is possible to filter the objects according to their size: too small, correct, too big. According to a preferred embodiment, shown in FIG. 10, the system for filtering tennis balls makes it possible to roll the objet introduced into the second module on two inclined parallel rails, of which the spacing has been adjusted in advance. The objects that are too narrow fall into a recovery bin while the other objects continue their travel on the rails. As such, by using two portions of rails, with different spacings E and E2, the balls can be separated from all of the objects.

According to the invention, the filtering operating procedure can include two phases. According to the first phase, the spacing E makes it possible for the objects that are too narrow to fall into a bin before being redirected towards the exit. The second phase corresponding to the spacing E2 allows the tennis balls to fall into a bin while the objects that are too big continue rolling on the rails before being redirected towards the exit. This device is interesting in that it uses only gravity to filter the objects. In addition, the number of parts required is reduced as much as possible.

According to the invention, the separation between the rails must advantageously be able to be adjusted simply and rapidly by a person in charge of maintaining the system. Indeed, the design was carried out in such a way that only a conventional tool of the screwdriver or wrench type is required to adjust the separations E and E2. In order to perform this adjustment, several technical solutions are possible. More preferably, a pivot system with screw and/or spring is used such as shown in FIG. 11, a system with tightening with screws and oblong holes such as shown in FIG. 13 or a system using the elastic deformation of the plate such as shown in FIG. 12. Still more preferably, the system with tightening with screws and oblong holes is used such as shown in FIG. 11. This system has for advantage in particular to suppress in part the problems linked with the adjusting of the separation between the rails. Indeed, even in the case of a deformation of the frame, the separation remains constant. According to the invention, the system can be arranged indoors, or outdoors.

When the system is arranged outdoors, it is preferentially energetically autonomous. The energy autonomy also falls in line with a sustainable development approach. In addition to the practical aspect (the terminal placed outdoors cannot be systematically connected to the network), the autonomy is a non-negligible argument. As such, more preferably, the energy autonomy of the system according to the invention is obtained by the use of a photovoltaic solar system.

Advantageously, the system according to the invention further comprises a communication module also called Media Player. Said communication module is more preferably integrated into the system and comprises a built-in dynamic screen 15 with directional sound. Said communication module can allow in particular the diffusion of programs or advertisements. Further advantageously, the communication module receives information relayed by satellite and/or by power line communication (PLC), i.e. that require a simple connection to the network power. This makes it possible to have ultra-light maintenance, self-repair functions, a remotely-controlled distribution of information and telematic management.

By way of example, this dematerialized communication makes it possible to save costs in publications in particular, allows for an acceleration in exchanges within the sector and also is in line with a sustainable development approach, in that it reduces waste linked to the publication of information. The communication module is advantageously a Tenniscreen® media which makes it possible in particular to diffuse a quality audiovisual loop that is updated on a regular basis, free spaces reserved for the communication of the club, the league or, for example, the French Tennis Federation.

By way of a non-restricted example of Media Player that can be used according to the invention, the models marketed by the Spinetix™ company can be mentioned, in particular the HMP100™.

According to another embodiment of the invention, the second module 21 further comprises a change machine 7 and a selection keyboard 6, as detailed hereinabove.

Advantageously, the system according to the invention can further contain:
one or several screens and/or one or several cut-outs for payment system 8 such as shown in FIG. 2;
one or several coin returns 9 such as shown in FIG. 2;
one or several closing valves such as shown in FIG. 2;
one or several wall fastenings 11 such as shown in FIG. 2 making it possible to maintain fastened the first and second modules 1 and 21;
one or several windows, preferentially thermo-isolated panoramic windows.

Advantageously, the first module according to the invention comprises an electronic or thermostat-controlled refrigeration system. More preferably, the refrigeration system is with electronic refrigeration maintains a temperature between +6° C. and +25° C., more preferably between +8° C. and +14° C., within the first module (1).

Indeed, the Applicant could highlight that the tennis balls and the tubes of tennis balls keep their original properties if their storage, before distribution, observes particular temperature conditions. The Applicant has shown that, at a temperature lower than +6° C., the quality of the tennis balls makes them unusable in play situation. In the same way, a temperature higher than +65° C. deteriorates the quality of the tubes of tennis balls, making them unsalable. Thus, according to the invention, while remaining in this interval of temperature ranging between +6° C. and +65° C., the balls of tennis as well as the tubes the container are well preserved and conserve their properties unaltered. This solution teaches away the prejudice according to which the conservation of the tennis balls, in particular the pressurized tennis balls, can only be improved by putting the aforementioned balls under pressure. It is indeed established that the pressurized balls of tennis contain a gas that escapes as time goes by, the tennis ball thus losing its pressure and becoming “limp”. To limit this process, in particular before the opening of the tube of tennis balls, the balls are thus pressurized, so that the pressure in the tube is higher than the pressure in the ball. The property of a gas is to circulate from the zones of high pressure to the zones of low pressure. Thus, the gas of the tennis ball thus remains in the aforementioned ball of tennis pressurized before its use. However, the incidence of the temperature of conservation on the quality of the balls of tennis, to date, was never taken into account during the storage of the balls of tennis before their use.

The invention further relates to a method for preserving, distributing and recovering balls for sports comprising the steps of filling said first module 1 for distributing articles; preserving said articles in a temperature range between +6° C. and +25° C., preferably between +8° C. and +14° C.; distributing said articles for payment of a corresponding sum; and recovering used or unusable tennis balls, empty tubes of tennis balls and/or other organic or inorganic waste in said second module 21.

According to the invention, the method can further contain a step according to which the used or unusable tennis balls, the empty tubes of tennis balls and/or the other organic or inorganic waste are reduced. The reduction can be carried out for example by crushing or shredding.

Advantageously, the method according to the invention further comprises a step of recycling used or unusable tennis balls, empty tubes of tennis balls and/or other organic or inorganic waste. More preferably, pertaining to the recycling of tennis balls, the recycling can fall within the framework of the “yellow ball operation” which consists in:
collecting balls during major tennis events in the system according to the invention;
grinding them in order to obtain aggregates;
recycling them into sports equipment such as sports mats or sports floor coverings.

As such, using approximately 40,000 recycled tennis balls, it is possible to obtain approximately 100 m² of sports floor covering.

Of course, the invention is not limited to the embodiments described and shown in the attached figures and those skilled in the art can, using routine operations, realize other embodiments that are not described explicitly, without leaving the framework and the scope of this invention.

1. A multifunction system comprising:
a first module (1) for the automatic distribution of articles; and
a second module (21) for the recovery of used or unusable tennis balls and/or empty tubes of tennis balls.

2. The system according to claim 1, wherein the first module (1) comprises an electronic or thermostat-controlled refrigeration system that maintains the temperature between +6° C. and +25° C. in said first module (1).

3. The system according to claim 2, wherein the temperature is maintained between +8° C. and +14° C. in said first module (1).

4. The system according to claim 1, wherein the articles are chosen from among balls for sports, tubes of tennis balls, tennis accessories, beverages and/or food.

5. The system according to claim 4, wherein the balls for sports are tennis balls.

6. The system according to claim 1, further comprising a communication module.

7. The system according to claim 1, further comprising a module for reducing the size of the tennis balls by shredding and/or of the size of the tubes of tennis balls by crushing.

8. The system according to claim 1, allowing for the recovery and/or the reduction of other organic or inorganic waste.

9. The system according to claim 1, further comprising a module for measuring the performance of tennis balls and/or a photovoltaic solar system making it possible to be energetically autonomous.

10. A method for preserving, distributing and recovering balls for sports comprising the steps of:
filling said first module (1) for the automatic distribution of articles;
preserving said articles in a temperature range between +6° C. and +25° C.;
distributing said articles for payment of a corresponding sum; and
recovering used or unusable tennis balls, empty tubes of tennis balls and/or other organic or inorganic waste in said second module (21).

11. The method according to claim 10, wherein the articles are preserved in a range between +8° C. and +14° C.

12. The method according to claim 10, wherein it comprises an additional step according to which the used or unusable tennis balls, empty tubes of tennis balls and/or other organic or inorganic waste are reduced and/or recycled.

13. A use of a multifunction system allowing for the automatic distribution of tubes of balls and of tennis balls, the recovery and/or the reduction of said tubes and tennis balls, before their recycling.

14. A tube of tennis balls stored in a system according to claim 1.
